(19) United States
(12) Patent Application Publication
(10) Pub. No.: US 2012/0018001 A1
(43) Pub. Date: Jan. 26, 2012

(54) Method for Improved Performance of a Functional Fluid

(75) Inventors: James D. Burrington, Gates Mills, OH (US); Jack C. Kelley, Chagrin Falls, OH (US); Lewis A. Williams, Willoughby Hills, OH (US); William D. Abraham, Concord, OH (US)

(73) Assignee: The Lubrizol Corporation, Wickliffe, OH (US)

(21) Appl. No.: 13/145,624

(22) PCT Filed: Jan. 28, 2010
(86) PCT No.: PCT/US10/22303

§ 371 Date: Oct. 6, 2011

Related U.S. Application Data
(60) Provisional application No. 61/150,812, filed on Feb. 9, 2009.

(51) Int. Cl. F15D 1/00

(52) U.S. Cl. 137/13

(57) ABSTRACT

In accordance with the invention, it has been discovered that the performance of a functional fluid, such as a lubricant, can be improved by following a method of operating a functional fluid using device, such as an engine, comprising: supplying to the device a functional fluid composition comprising an additive package; operating the device containing the functional fluid composition; and adding to the functional fluid composition, during the operation of the device, a supplemental additive package; resulting in a performance improvement of the functional fluid composition during its service life and/or an extension of the functional fluid composition's service life, and so an improvement in the performance of the device.

### FIELD OF THE INVENTION

The invention relates to a method for improving the performance of a functional fluid, such as a lubricant. The invention relates to a method of using a functional fluid in the operation of a piece of equipment and/or mechanical device where the fluid is used in combination with a supplemental package of additives. The additives are supplied to the fluid during the fluid's use in the operation of said equipment, resulting in improved performance of the fluid, and so the equipment.

### BACKGROUND OF THE INVENTION

Functional fluids, such as lubricants, degrade over time through use. The additives in the fluids deplete over the lifetime of the fluid in an engine or other mechanical device. Time release additives for fluids, such as engine oil, are known. These additives are typically incorporated into thermoplastic polymers which slowly dissolve into the engine oil, see U.S. Pat. No. 4,075,098. Time release additives have also been incorporated into polymers which are oil-permeable at elevated engine temperatures, see U.S. Pat. No. 4,066,559.

Replenishment of desired additives into a functional fluid improves the performance of the fluid and the device using the fluid. Use of controlled release gels, as described in U.S. Pat. No. 6,843,916, has been shown to be an effective means to replenish a fluid with fresh additives over time. Such gels are formed by incorporating additive components into a gel matrix, which results in the interaction of a basic component and an acidic component, forming the gel.

With increasing demands on functional fluids, to perform for longer periods of time, to perform under harsher operating conditions, and to provide improved performance, there remains a need for methods of improving the performance of functional fluid, and so improving the performance of the devices and equipment in which they are used.

### SUMMARY OF THE INVENTION

The invention provides a method of operating a functional fluid-utilizing device comprising: supplying to the device a functional fluid composition comprising an additive package, wherein the additive package may be a standard additive package, a specialized additive package or an additive package that has a deficient amount of one more types of additives; operating the device containing the lubricating composition; adding to the lubricating composition, during the operation of the device, a supplemental additive package in a controlled manner; resulting in a performance improvement of the functional fluid composition during its service life and/or an extension of the functional fluid composition's service life.

The methods of the invention may result in increased functional fluid durability; reduced soot and/or soot thickening in the functional fluid; an extended drain interval and/or service life for the functional fluid; or combinations thereof.

The functional fluid of the invention may be a lubricating composition and the device may be an engine. In such embodiments the lubricant may contain an amount of friction modifier below the minimum amount required for the composition to obtain a passing result in the VIB engine test; may contain an amount of antioxidant below the minimum amount required for the composition to obtain a passing result in the IIE engine test; or combinations thereof.

The methods of the invention provide a performance improvement in the functional fluid composition, which may include: increased fluid durability; reduced soot and/or soot thickening; extended drain interval and/or fluid service life; and combinations thereof.

### DETAILED DESCRIPTION

Various preferred features and embodiments will be described below by way of non-limiting illustration.

The invention provides for a means of using a functional fluid composition and a supplemental additive package, resulting in improved performance of the fluid and so improved performance of the piece of equipment and/or mechanical device that utilizes the fluid in its operation. The improvement in performance of the fluid may be in the form of providing increased protection of the device over extremely long, severe and/or low maintenance service periods.

This can be accomplished by formulating the functional fluid composition to focus on providing certain performance while ignoring and/or not fully addressing others, and using the supplemental additive package, supplied separately to the fluid system during operation of the device, to provide for these gaps. This balance between the fluid and supplemental package allows formulators and device operators to use highly specialized fluids. The invention can remove one or more of the formulation constraints discussed below and allow for the functional fluid to be tailored to address more specific areas of protection and/or performance without the need for it to address all areas. This otherwise non-attainable customization and/or specialization of the fluid is made possible only through the use of the supplemental additive package, which is designed to fill in the gaps in the fluid's abilities that resulted from its additional focus and/or specialization/customization. The combined use of the specialized fluid, which may also be called a “deficient” fluid, and the supplemental package allow for improvements in the performance of the fluid, and so the device utilizing the fluid, not otherwise attainable by either composition alone.

In other embodiments a standard functional fluid may be used with the supplemental additive packages of the invention to improve the performance of the fluid. In such embodiments the fluid may still be specialized and/or customized, but would be sufficient to effectively operate the fluid utilizing device. The use of such fluids with the supplemental packages of the invention, in the methods described, would result in fluid performance not otherwise attainable by the fluid alone.

In other embodiments a functional fluid may be fully formulated (a standard fluid), but over the course of its use, it may become deficient and/or less effective in one or more performance areas. In such embodiments the methods of the present invention, utilizing a supplemental additive package, results in improved and/or extended performance of the functional fluid.

In still other embodiments the functional fluid may be fully formulated for a specific application and/or piece of equipment and is then used in a different application and/or piece of equipment which may have different performance needs. The supplemental additive package may be used with the fluid to enable it to provide acceptable performance in the new application and/or piece of equipment. Thus the package may be used to allow the use of a fluid in applications and/or pieces of equipment for which the fluid was not specifically designed and still provide the required performance and protection.

In still other embodiments, the supplemental additive package may provide one or more additives to the functional fluid that would not survive the service life of the fluid during its use. Many additives break down over time, particularly when present in a high temperature and/or stress environment. One means of addressing this issue is to increase the treat rate of such additives in the fluid, but this is costly and still leads to diminished performance later in a fluid's service life. The methods herein allow for one or more of these fragile additives to be delivered to the fluid over time from the supplemental package, thus allowing a lower overall treat rate of these additives while ensuring effectiveness over the full service life of the fluid. Fragile additives include, but are not limited to, antioxidants, friction modifiers and antifoam agents.

In any of the embodiments described above, the device of the invention may be an engine and the functional fluid may be a lubricant, such as an engine oil. In some of these embodiments the improvement of performance is an increase in drain intervals and/or the ability of the oil to provide good protection of the engine under harsh and/or severe operating conditions.

The Device. The piece of equipment and/or mechanical device suitable for use in the invention includes any device that uses one or more functional fluids in its operation. Such devices include those that utilize lubricants, and more specifically those that utilize: gear oil, transmission oil, hydraulic fluid, engine oil, two cycle oil, metalworking fluid, fuel, and the like during their operation. In some embodiments, the device is: an internal combustion engine, which includes engines for mobile and stationary applications as well as gasoline, diesel, biofuel, and compressed natural gas (CNG) fueled engines and further includes aviation engine, marine engines, and railroad engines; a generator, an electric motor, a hydraulic system; an automatic transmission; a gear box, which includes manual transmissions and differentials; a metalworking fluid; a pump, compressor, or similar piece of equipment; a suspension system; other lubricated mechanical systems; and the like.

In many embodiments the device of the invention is an internal combustion engine. The engines suitable for use in the invention are not overly limited so long as the engine utilizes at least one lubricating composition, or other functional fluid, in its operation. The engine may include one or more of the types described above.

The Functional Fluid Composition. The functional fluids suitable for use in the invention include lubricants. In some embodiments the functional fluid is gear oil, transmission oil, hydraulic fluid, engine oil, two cycle oil, metalworking fluid, fuel, and the like. In one embodiment the functional fluid is an engine oil. In another embodiment the preferred functional fluid is gear oil. In another embodiment the preferred functional fluid is transmission fluid. In another embodiment the preferred functional fluid is a hydraulic fluid.

Functional fluid compositions suitable for use in the invention comprise some amount of an additive package, wherein the additive package may have a “deficient” amount of one more types of additives. The lubricating compositions suitable for use in the invention comprise a major amount of an oil of lubricating viscosity and a minor amount of an additive package, wherein the additive package has a “deficient” amount of one more types of additives.

The functional fluid compositions of the invention, as noted above, may be referred to as “deficient” in that they do not address all protection and/or performance issues that the composition should and/or could address for the device in which it is to be used. The composition may also be described, again as noted above, as “specialized” in that the fluid is designed to focus on one or more specific areas of performance, at the expense of other areas to an extent not otherwise possible if the fluid were to be used alone (not in the method of the invention). This deficiency and/or specialization may be the result of the composition having a limited or reduced amount of one or more specific types of additives generally needed to provide the protection and/or performance in one or more areas. The composition may even be substantially or even completely lacking one or more specific types of additives which would generally be present in such a fluid.

This “deficiency” of the fluid in some areas allows the composition to be formulated in such a way as to provide protection and/or performance in other areas not otherwise possible, hence its description as “specialized”. While the functional fluids of the invention are capable of providing superior performance and/or protection in one or more areas, they may not capable of providing improved, or in some cases even sufficient, performance and/or protection in all areas alone (if used as a conventional fluid without the supplemental package of the invention).

Functional fluid compositions, such as lubricating compositions, are formulated to provide a balance between many conflicting and/or competing requirements including: required physical characteristics such as viscosity across temperature and use; the ability for the formulation to meet both general and specific performance standards; remaining below maximum allowable amounts of various metals and other compounds such as sulfur, phosphorus and/or ash; solubility and compatibility of additives with one another and with the base fluids used is the composition, which may limit the amount and type of certain additives that may be used and may even limit which additives may be used together; and the overall cost of various components and the formulation, to name a few. The performance standards referred to above include general evaluations of the formulations ability to provide good performance over the service life of the composition, the length of that service life, and also include specific standards of achieving passing results in highly specialized tests, for example engine test protocols. Many times, if not always, in the development of functional fluids, such as lubricants, formulations are modified to improve the composition in one of these areas at the expense of another. The additives used to formulate such compositions include all of those additives described below, particularly those described under components (a), (b) and (c) of the gel compositions, with the understanding that the functional fluid compositions do not form gel compositions.

In some embodiments, the term “deficient amount” of additive as used herein means an amount below the minimum amount required for the composition to pass one or more performance tests and/or quality specifications. In other embodiments a deficient amount of a type of additive is an amount 10%, 20%, or 50% less than the minimum and/or typical amount used in conventional functional fluid compositions in the same application. In other embodiments, a deficient amount of a type of additive may mean none of that additive type is present at all and/or substantially none of the additive type is present, that is, so little is present that the performance of the functional fluid composition would be substantially the same as if there were none of that additive and/or additive type present.

In some embodiments, the deficient functional fluid is a lubricating composition which contains an amount of friction modifier below the minimum amount required for the composition to obtain a passing result in the VIB engine test. In other embodiments, the deficient functional fluid is a lubricating composition which contains an amount of friction modifier below the minimum amount required for the composition to maintain a coefficient of friction <0.11, as measured by the high frequency reciprocating rig described in SAE Paper 2007-01-4134.

In some embodiments, the deficient functional fluid is a lubricating composition which contains an amount of antioxidant and EP/antiwear below the minimum amount required for the composition to obtain a passing result in the IIIG engine test (for the GF-4 specification in gasoline engines) and/or the Mack T12 test (for the CJ-4 specification in Diesel engines).

In some embodiments, the deficient functional fluid is a lubricating composition which contains an amount of detergent below the minimum amount required for the composition to obtain a passing result in ASTM D6557 Ball Rust Test (for GF-4 in gasoline engines) and/or the Mack T12 test (for CJ-4 in Diesel engines).

In some embodiments, the deficient functional fluid is a lubricating composition which contains an amount of dispersant below the minimum amount required for the composition to obtain a passing result in the Sequence IIIGA test (for GF-4 in gasoline engines) and/or the Mack T11A test (for CJ-4 in Diesel engines).

In some embodiments, the deficient functional fluid is a lubricating composition which contains an amount of antifoam agent below the minimum amount required for the composition to obtain passing results for GF-4 and/or CJ-4 in the ASTM D 892 A and/or D 6082 A tests.

In some embodiments the lubricating composition of the invention contains a deficient amount of detergent and/or dispersant additives. The amount of detergent and/or dispersant additives present may be <20%, <15%, <10%, <5%, <1%, <0.5%, or <0.1% by weight of the lubricating composition, or there may be no detergent and/or dispersant additives present in the lubricating composition at all.

In some embodiments the lubricating composition of the invention contains a deficient amount of viscosity modifier. The viscosity modifier present may be <10%, <5%, <1%, <0.5%, or <0.1% by weight of the lubricating composition, or there may be no viscosity modifier type additives present at all.

In some embodiments the lubricating composition contains a deficient amount of friction modifiers and/or lubricity aids. The additives may be <10%, <5%, <1%, <0.5%, or <0.1% by weight of the lubricating composition, or there may be no friction modifiers and/or lubricity aids present at all.

In some embodiments the lubricating composition contains a deficient amount of cloud point depressants and/or pour point depressants and/or flow improvers. The additive(s) may be <1%, <0.5%, or <0.1% by weight of the lubricating composition, or there may be none of one or more of these types of additives present at all.

In some embodiments the lubricating composition contains a deficient amount of antioxidants and/or corrosion inhibitors and/or rust inhibitors. The additive(s) may be <10%, <5%, <1%, <0.5%, or <0.1% by weight of the lubricating composition, or there may be none of one or more of these additives present at all.

In some embodiments the lubricating composition contains a deficient amount of antifoam agents and/or antimisting agents and/or antistatic agents. The additives) may be <5%, <1%, <0.5%, or <0.1% or 0.02% by weight of the lubricating composition, or there may be none of one or more of these additives present at all.

In some embodiments the lubricating composition of the invention contains a deficient amount of extreme pressure agents. The additive(s) may be <10%, <5%, <1%, <0.5%, or <0.1% by weight of the lubricating composition, or there may be none of one or more of these additives present at all.

In some embodiments the lubricating composition of the invention contains a deficient amount of demulsifiers and/or seal swell agents. The additive(s) may be <5%, <1%, <0.5%, or <0.1% by weight of the lubricating composition, or there may be none of one or more of these additives present at all.

In some embodiments, two or more of the types of additives described above are present in deficient amounts in the lubricating composition and/or are not present in the starting lubricating composition at all. In other embodiments, the functional fluid used in the present invention is “deficient” in one or more of the ways described above, but only after some period of use in the functional fluid utilizing device. That is, the functional fluid may be a typical, fully formulated fluid, containing sufficient amounts of all necessary additives, but which over time and/or use, the fluid become deficient in one or more ways.

As described in the section above, the functional fluid used in the methods of the invention may be deficient, as described above, before its use or at some point during its use. In addition, the fluid may never become deficient due to its use in combination with the supplemental additive packages described below.

The Supplemental Additive Package. The supplemental additive package suitable for use in the invention comprises one or more performance additives. The package is designed to be used in combination with the functional fluid composition such that the combination provides for all the areas of protection and/or performance the device, such as an engine, requires, including those areas left unaddressed and/or under-addressed by the fluid.

In some embodiments the additives that make up the supplemental additive package include one or more of the types of additives that are deficient in the functional fluid composition described above. In some embodiments the additives that make up the package do not include one or more of the types of additives that are deficient in the fluid described above, however, the package still provides complimentary performance with the fluid composition to provide for all areas of performance and/or protection required by the device. The package may comprise any of the additives described below, particularly those described as components (a), (b) and (c) of the gel compositions, whether the package is a gel composition or not.

The supplemental additive package may be a liquid, a solid, or gel composition or combinations thereof. The package may be a fully formulated functional fluid, such as a fully formulated engine oil. However, in other embodiments the package is not a fully formulated additive package.

The supplemental additive package may be designed to release additives into the functional fluid: almost immediately, quickly over a short period of time, slowly over a longer period of time, very slowly over the entire service life of the lubricating composition, or combinations thereof. The package may be designed to release and/or deliver to a lubricating composition: conventional lubricant additives, additives which are substantially insoluble and/or incompatible with the lubricating composition, or combinations thereof.

Gel Supplemental Additive Packages. Where the supplemental additive package is a gel composition, the additive package is semi-solid that is neither a liquid nor a solid. The controlled release gel compositions suitable for use in the invention may contain conventional performance additives and/or the incompatible additive described below, and allow for the controlled release of one or more of these additives into the functional fluid composition with which it is used.

Suitable gel compositions are typically made by blending of a mixture of additives selected to simultaneously provide the desired performance and to form a gel upon mixing or mixing with subsequent thermal curing. In some embodiments, the gel composition is formed by combining at least two components selected from the group consisting of: detergents, dispersants, acids, bases, over based detergents, and succinated polyolefins. The components are selected, and combined in specific ratios, so that when combined, they form a gel.

Gel supplemental additive packages deliver additives to the lubricating composition by means of dissolution and/or extraction of the additives in the supplemental additive package to the lubricating composition. This transfer takes place when the supplemental additive package and the lubricating composition come into contact with one another. The rate of transfer depends on the conditions at the time of contacting and the formulation of the gel supplemental additive package.

The gels may be formed in the presence of one or more additives which are to be released and/or delivered to the fluid, but which do not participate in the formation of the gel. In other embodiments, the additive to be released actively participates in gel formation. In still other embodiments, when multiple additives to be released are present, combinations of the above embodiments may occur.

In some embodiments the additives to be released can be added to, dispersed into or melted into one or more of the components that form the gel composition. The components may then be combined to form the gel. In other embodiments, the additive may be added as a separate component to the other components present before, during or after the formation of the gel.

In some embodiments the gel's formulation is composed of: (a) a basic component comprising an overbased detergent, an ashless dispersant, or mixtures thereof; (h) an acidic component comprising a maleic anhydride styrene-copolymer, an ashless dispersant, polyolefin, succinated polyolefin or mixtures thereof; and (c) an additive component to be delivered to the lubricating composition.

In some embodiments component (c): may be substantially insoluble in, has low solubility in, or is otherwise incompatible with the lubricating composition, as described above and referred to as an “incompatible additive” herein.

Component (a). The basic component comprises an overbased detergent, an ashless dispersant with a total base number (TBN) greater than 13, or mixtures thereof. Dispersants suitable for use in component (a) include ashless dispersants such as a polyisobutylene succinimide and the like so long as the dispersant has a total base number (TBN) greater than 13. Polyisobutylene succinimide ashless dispersants are commercially-available products which are typically made by reacting together polyisobutylene having a number average molecular weight (M″) of about 300 to 10,000 with maleic anhydride to form polyisobutylene succinic anhydride (PIBSA) and then reacting the product so obtained with a polyamine typically ethylene polyamines containing 2 to 10 nitrogen atoms per molecule. Detergents suitable for use in component (a) include overbased sulfonates, phenates, salicylates, carboxylates, overbased detergents containing metals such as Mg, Ba, Sr, Na, Ca and K and mixtures thereof and the like.

Component (a) may further comprise copolymers such as ethylene-propylene diene monomer (EPDM) copolymer. Suitable EPDM copolymers include those with a number average molecular weight between 1×10² and 1×10⁹. In one embodiment component (a) comprises a copolymer, an overbased detergent, or a combination thereof. In one embodiment the copolymer comprises an EPDM copolymer, an overbased calcium hydroxide alkylbenzenesulfonate detergent, or combinations thereof.

In other embodiments, component (a) and/or the gel composition overall and/or the supplemental additive package overall, in combination with any of the embodiments described above or below, is free of polymers or polymeric materials that form a matrix and/or facilitate the release of one or more additives of the supplemental additive package to the lubricating composition.

Component (a), the basic component, is present in ranges such that the weight ratio of component (a) to component (b) is, in one embodiment, 0.01 to 0.99, and in another embodiment 0.05 to 0.2. This corresponds to a range of about 1% by weight to about 100% by weight in one embodiment for the combined components (a) and (b) in the gel, and a range of about 1% by weight to about 50% by weight in another embodiment. As to component (a) alone, the gel may be, in one embodiment, about 0.1% by weight to about 80% by weight component (a) and in another embodiment, about 0.5% by weight to about 70% by weight component (a). In still other embodiments, component (a) is present in the gel from 0.5% by weight to 60% by weight, from 30 to 60% by weight, from 40 to 60% by weight, from 50 to 60% by weight, or from 55 to 58% by weight.

Component (b). The acidic component may comprise a functionalized polymer with an acidic group, an ashless dispersant, a polyolefin, a succinated polyolefin or mixtures thereof. Functionalized polymers useful in the invention include olefin copolymers and acrylate or methacrylate copolymers. Functionalized olefin copolymers can be, for instance, interpolymers of ethylene and propylene which are grafted with an active monomer such as maleic anhydride and then derivatized with an alcohol or an amine. Other such copolymers are copolymers of ethylene and propylene which are reacted or grafted with nitrogen compounds. Derivatives of polyacrylate esters are well known as dispersant viscosity index modifiers additives. Dispersant acrylate or polymethacrylate viscosity modifiers such as Acryloid™ 985 or Viscoplex™ 6-054, from RohMax, are particularly useful.

In one embodiment, the acidic component of the invention comprises maleic anhydride styrene copolymer (MSC) and may further comprises an ashless dispersant. The MSC may be partially esterified with an alcohol where the equivalent ratio of alcohol to acid groups is in one embodiment from about 0.1 to about 0.99 and in another embodiment from 0.45 to 0.95. Appropriate alcohols for use in preparing the copolymer include alcohols containing 6 to 32 carbon atoms, and in another embodiment, alcohols containing 8 to 18 carbon atoms. Suitable MSC comprise those with a total acid number (TAN), in one embodiment, greater than 1, and in another embodiment greater than 3 where TAN is in the units of milligrams of KOH per gram of material.

The ashless dispersants suitable for use in component (b) are the same as the dispersants described above in regards to component (a) except that suitable ashless dispersants for use in component (h) have a measurable total acid number (TAN). In some embodiments the dispersant has a TAN greater than 15. In one embodiment, component (b) comprises a polyisobutylene succinimide dispersant.

Component (b), the acidic component, is present in ranges such that the weight ratio of component (a) to component (b) is typically 0.01 to 0.99, and more typically 0.05 to 0.2. This corresponds to a range of about 1% by weight to about 100% by weight in one embodiment for the combined components (a) and (b) in the gel, and a range of about 1% by weight to about 50% by weight in another embodiment. As to component (b) alone, the gel may be, in one embodiment, about 0.5% by weight to about 99% by weight component (b) and in another embodiment, about 0.5% by weight to about 98% by weight component (a). In other embodiment component (b) may be present in the gel from 0.1% to 40% by weight, from 0.1% to 20% by weight, from 0.1% to 10% by weight, or from 5 to 10% by weight.

Component (c). This component generally contains one or more additives to be delivered to the functional fluid which may or may not participate in the gel formation. These additives include viscosity modifiers, friction modifiers, detergents, cloud point depressants, pour point depressants, demulsifiers, flow improvers, anti static agents, dispersants, dispersant-viscosity index improvers, antioxidants, antifoams, corrosion/rust inhibitors, extreme pressure/antiwear agents, seal swell agents, lubricity aids, antimisting agents, and mixtures thereof, with the proviso that these additional additives are not the same as the additives present in any of the other components in the gel composition, though they may be the same type of additive.

Component (c) is present in ranges such that the weight ratio of component (c) to the combined total of components (a), (b) and (c) is typically 0.001 to 0.99, and more typically 0.01 to 0.5. This corresponds to a range of about 0% by weight to about 99% by weight in one embodiment of component (c) in the gel and a range of about 1% by weight to about 50% by weight in another embodiment. In other embodiments component (c) is present in the gel from 0.1% to 40% by weight, from 0.1% to 30% by weight, from 0.1% to 15% by weight, from 10 to 20% by weight, or from 10 to 15% by weight.

Suitable antioxidants include alkyl-substituted phenols, sterically hindered phenols (such as 2,6-di-tert-butylphenol), and hindered ester-substituted phenols. Suitable extreme pressure/anti-wear agents include sulfur and/or chlorosulphur EP agents, chlorinated hydrocarbon EP agents, phosphorus EP agents, or mixtures thereof. Suitable antifoams include organic silicones such as polydimethylsiloxane, polydiethylsiloxane, polyacrylates and polymethacrylates, trimethyl-trifluoro-propylmethyl siloxane and the like. Suitable viscosity modifiers include copolymers of vinyl pyridine, N-vinyl pyrrolidone and N,N′-dimethylaminoethyl methacrylate as well as polyacrylates obtained from the polymerization of one or more alkyl acrylates. Suitable friction modifiers include organo-molybdenum compounds, including molybdenum dithiocarbamate, and fatty acid based materials, including those based on oleic acid (such as glycerol mono oleate) and stearic acid. Suitable anti-misting agents include very high (>100,000 number average molecule (Mn)) polyolefins such as polyisobutylene derived from 1.5 k Mn (for example the material of the trades name Vistanex®), or polymers containing 2-(N-acrylamido)-2-methyl propane sulfonic acid (also known as AMPS®), or derivatives thereof, and the like. Suitable corrosion inhibitors include alkylated succinic acids and anhydrides derivatives thereof, organo phosphonates and the like. The rust inhibitors may be used alone or in combination. Suitable metal deactivators include derivatives of benzotriazoles (such as tolyltriazole and the like). Suitable demulsifiers include polyethylene oxide and polypropylene oxide copolymers and the like. Suitable lubricity aids include glycerol monooleate, sorbitan monooleate and the like. Suitable flow improvers include ethylene vinyl acetate copolymers and the like. Suitable cloud point depressants include alkylphenols and derivatives thereof, ethylene vinyl acetate copolymers and the like. Suitable pour point depressants include alkylphenols and derivatives thereof, ethylene vinyl acetate copolymers and the like. Suitable seal swell agents include organo sulfur compounds such as thiophene, 3-(decyloxy)tetrahydro-1,1-dioxide (i.e. 3-decyloxysulfolane) and the like.

In some embodiments component (c) may comprise dispersants and detergents such as those described in regards to components (a) and (b). In addition, component (c) may also comprise additional types of dispersants. These additional types of dispersants include Mannich dispersants, carboxylic dispersants, amine dispersants, and polymeric dispersants. The Mannich dispersants are the reaction products of alkyl phenols in which the alkyl group contains at least about 30 carbon atoms with aldehydes (especially formaldehyde) and amines (especially polyalkylene polyamines). Another class of dispersants is carboxylic dispersants. Examples of these dispersants are described in U.S. Pat. Nos. 3,219,666, 4,234,435 and 3,172,892. Amine dispersants are reaction products of relatively high molecular weight aliphatic halides and amines, preferably polyalkylene polyamines. Examples thereof are described, in U.S. Pat. No. 3,565,804. Polymeric dispersants are interpolymers of oil-solubilizing monomers such as decyl methacrylate, vinyl decyl ether and high molecular weight olefins with monomers containing polar substituents, e.g., amino alkyl acrylates or acrylamides and poly-(oxyethylene)-substituted acrylates. Examples of polymer dispersants thereof are disclosed in the following U.S. Pat. Nos. 3,329,658 and 3,702,300.

Dispersants can also be post-treated by reaction with any of a variety of agents. Among these are urea, thiourea, dimercaptothiadiazoles, carbon disulfide, aldehydes, ketones, carboxylic acids, hydrocarbon-substituted succinic anhydrides, nitriles, epoxides, boron compounds, and phosphorus compounds.

In addition, component (c) may also comprise dispersant-viscosity index improvers, which can be a functionalized olefin copolymer. Such materials are described in greater detail in US 2007/000464, hereby incorporated by reference. The polymer or copolymer substrate used to prepare these materials can be derived from ethylene and propylene or it can be prepared from ethylene and at least one higher olefin containing 3 to 23 carbon atoms. The terms polymer and copolymer can be used generically to encompass ethylene copolymers, terpolymers or interpolymers. These materials can comprise minor amounts of other olefinic monomers so long as the basic characteristics of the ethylene copolymers are not materially changed.

An ethylenically unsaturated carboxylic acid material can next be grafted onto the prescribed polymer backbone to form an acylated ethylene copolymer. The carboxylic reactants can be selected from acrylic, methacrylic, cinnamic, crotonic, maleic, fumaric and itaconic reactants. As a further example, the carboxylic reactants can be selected from maleic acid, fumaric acid, maleic anhydride, and a mixture of two or more of these.

The acylated olefin copolymers can be reacted with coupling compounds and performance enhancing compounds. For purposes of the present disclosure, coupling compounds can be defined as those compounds containing more than one amine, thiol and/or hydroxy functional groups capable of reacting with the acylated olefin copolymer so as to link or couple two or more acylated olefin copolymers. The performance enhancing compound includes a polyamine compound selected from: (a) an N-arylphenylenediamine; (b) an aminothiazole selected from the group consisting of aminothiazole, aminobenzothiazole, aminobenzothiadiazole and aminoalkylthiazole; (c) an aminocarbazole; (d) an aminoindole; (e) an aminopyrrole; (f) an amino-indazolinone; (g) an aminomercaptotriazole; (h) an aminopyrimidine; (i) an aminoalkyl imidazole, such as 1-(2-aminoethyl) imidazole, 1-(3-aminopropyl) imidazole; and (j) aminoalkyl morpholines, such as 4-(3-aminopropyl) morpholine. Optionally, other components can be added to the additive gel which includes base stock oils, inert carriers, dyes, bacteriostatic agents, solid particulate additives, and the like so long as the free standing additive gel is maintained.

In some embodiments the gels of the invention are free from thermoplastic polymers. In such embodiments the gels of the invention may be substantially free of thermoplastic polymers or completely free of thermoplastic polymers.

The gel compositions of the invention exist in a semi-solid state more like a solid than a liquid, see Parker, Dictionary of Scientific and Technical Terms, Fifth Edition, McGraw Hill, © 1994. See, also, Larson, “The Structure and rheology of Complex Fluids”, Chapter 5, Oxford University Press, New York, N.Y., © 1999, each which is incorporated herein by reference. The rheological properties of a gel can be measured by small amplitude oscillatory shear testing. This technique measures the structural character of the gel and produces a term called the storage modulus which represents storage of elastic energy and the loss modulus which represents the viscous dissipation of that energy. The ratio of the loss modulus/storage modulus, which is called the loss tangent, or “tan delta”, is >1 for materials that are liquid-like and <1 for materials that are solid-like. The gels of the invention have tan delta values in one embodiment of about ≦0.75, in another embodiment of about ≦0.50 and in another embodiment of about ≦0.25. The gels have tan delta values in one embodiment of about 0.1 to 0.75, in one embodiment of about 0.15 to 0.50, in one embodiment of about 0.20 to 0.33.

Another means of evaluating the firmness or stiffness of an additive gel is to measure its cone penetration value, or cone pen. Cone pens may be measured by ASTM D217 and ASTM D1403 and these test methods are often used to test the stiffness and consistency of greases. These test procedures involve measuring the amount of penetration a specifically sized and contoured cone reaches in a sample of material after a specified period of time. The smaller the cone pen value, the more stiff and/or firm the fluid additive gel. The gels of the invention have cone pen values, measured by ASTM D 217 using a ¼ pen, as referred to in the procedure, from about 0 to about 100, in another embodiment from about 0 to about 50, and in another embodiment from about 0 to about 20. The gels have cone pen values in one embodiment of about ≦100, in one embodiment of about ≦50, in one embodiment of about ≦20. These cone pen values are in tenths of millimeters and are not adjusted for scale.

In some embodiments the gel compositions of the invention may be free standing gel compositions. A gel is described as “free standing” when, after it is has been prepared, it is firm and solid-like enough that it can retain its shape and dimensions when removed from, and no longer supported by, a container or device, such as the container in which the gel was prepared. In some embodiments the gel retains these free-standing qualities indefinitely, in other embodiments the gel retains these qualities for at least 6 hours, for at least 1 hour, or for at least 15 minutes. In some embodiments free standing gel compositions have tan delta values, as described above, of about 0.1 to 0.33, in one embodiment of about 0.15 to 0.33, in one embodiment of about 0.20 to 0.33 or in one embodiment of about 0.21 to 0.33. In some embodiments free standing gel compositions have cone pen values, as described above, from about 40 to about 75, in another embodiment from about 40 to about 70, and in another embodiment from about 45 to about 70.

The additive gel compositions of any of the embodiments described above typically contain small amounts (about 5-40%) of base stock oils, which include but are not limited to mineral-based, synthetic or mixtures thereof. Optionally, an inert carrier can be used if desired. Furthermore, other active ingredients, which provide a beneficial and desired function, can also be included in the gel. In addition, solid, particulate additives such as the PTFE, MoS₂ and graphite can also be included. In some embodiments the gel compositions of the invention may release, in a controlled manner, these additional components, including the base stock oil, into a functional fluid. In some embodiments, the invention includes a supplemental additive package that releases base oil, and optionally other performance additives as well, into the functional fluid. This release of base oil may allow for improved viscosity control in the functional fluid over its service life.

The components of the gel composition are mixed together sequentially in any order or all together to form a mixture. After mixing of the components of the gel, a cure may be required in order for gelation to occur. If a cure is required, it is typically done in the range of about 20° C. to about 165° C. for about 1 minute to about 60 days, preferably at about 50° C. to about 120° C. for about 1 to about 24 hours, more preferably at about 85° C. to about 115° C. for about 4 to about 12 hours.

Liquid Supplemental Additive Packages. Where the supplemental additive package is a liquid composition, it may be used with the functional fluid composition by adding the liquid composition to the functional fluid composition before, during and/or after the operation of the device that uses the functional fluid. The liquid composition may be added to the functional fluid composition all at once, as a single dose, however, in some embodiments the liquid composition is added over time, in the form of two, three, four or more additions, or even in the form of a near-continuous to continuous dosing over time.

The liquid composition may be added to the functional fluid composition at any point/location in the functional fluid system of the device. In some embodiments the liquid composition is added to and/or dosed into the oil sump of an engine. In other embodiments the liquid composition is added to and/or dosed into the crankcase of an engine and/or an oil filter and/or an oil line. The liquid composition may be added manually in two or more portions to a device during its operation, or an automatic dosing may be used to add the liquid composition over time at a controlled rate, or one or more controlled release capsules which are submerged and/or in contact with the functional fluid during the operation of the device may be used where the capsule which contains the liquid dissolves and/or allows for the transfer of the liquid composition to the functional fluid over time. Combinations of these various means of delivery may also be used.

The liquid compositions of the invention may comprise one or more of the incompatible additives described below and/or may comprises any of the additives described above for components (a) and (b) that make up the gel compositions, with the proviso that the components of the liquid supplemental additive compositions do not interact to form a gel. The liquid compositions of the invention may also comprise the optional additional additives described above for component (c).

In some embodiments the liquid supplemental additive packages of the invention may be added to a functional fluid in the form of a top treat or similar after-market method. Such additions may be made in by any of the means discussed in the sections below.

Solid Supplemental Additive Packages. Where the supplemental additive package is a solid composition, the additive package is a solid at room temperature. In such embodiments, the solid composition is not a gel. Rather the composition is a mixture of one or more additives that is solid at room temperature and which will mat to form a liquid at higher temperatures and will re-freeze at lower temperatures.

Solid supplemental additive packages deliver additives to the functional fluid composition by means of melting, dissolution, and/or extraction of the additives in the supplemental additive packages to the functional fluid composition. This transfer takes place when the supplemental additive package and the functional fluid composition come into contact with one another. The rate of transfer depends on the conditions at the time of contacting and the formulation of the solid supplemental additive package.

In some embodiments the solid compositions have a melting point of 40 degrees C. or higher, 70 degrees C. or higher, 100 degrees C. or higher, or 130 degrees C. or higher. In some embodiments the melting point of the solid additive composition is at or below the service temperature the lubricating system reaches during the operation of an engine. In those cases the additives present in the solid additive composition will be quickly released into the lubricating composition by melting. In other embodiments, the solid compositions have a melting point at least just above the service temperature the lubricating system reaches during operation of an engine to 50 degrees C. above. For example, the melting point of an solid composition designed to deliver an additive which is substantially insoluble or has low solubility in engine oil may have a melting point which is just above the temperature the engine oil reaches during its use in an operating engine. In such embodiments the formulation of the solid additive composition is carefully balanced in order to result in the desired melting point, allowing the solid additive composition to remain in solid form while exposed to the functional fluid during the service life of the functional fluid.

In some embodiments the melting point of the solid composition is 5 degrees C. above the service temperature of the lubricating system during the operation of an engine. In other embodiments the solid additive composition is 10 degrees C. or 20 degrees C. or more above the service temperature.

The solid compositions of the invention may comprise one or more of the incompatible additives described below and/or may comprises any of the additives described above for components (a) and (b) that make up the gel compositions, with the proviso that the components of the solid supplemental additive compositions do not interact to form a gel. The solid compositions of the invention may also comprise the optional additional additives described above for component (c).

Incompatible Additives. In some embodiments of the invention the supplemental additive package may comprise one or more incompatible additives, that is, additives which are substantially insoluble in, have low solubility in, or are otherwise incompatible in the functional fluid. Such additives may still be supplied to the functional fluid by means of the invention where the supplemental additive package contains the incompatible additive and compensates for the incompatibility. The compensation can occur by allowing a low level of the incompatible additive in the fluid, in some cases the highest level of the incompatible additive that will remain soluble in the fluid, to be continually replenished over the service life of the fluid, thus allowing the fluid to effectively benefit from the otherwise incompatible additive that would not be present in sufficient amounts to be useful due to solubility limits and degradation of the additive over time.

The supplemental additive compositions of the invention may comprise a mixture of two or more substantially insoluble or low solubility additives. In embodiments where two components are present, the ratio of the two components, on a weight basis, is between 1:99 to 99:1. In some embodiments the ratio is 25:75 to 75:25, or 60:40 to 40:60. In other embodiments, the components themselves and the ratio of the components is selected to produce a solid composition with the desired melting point and/or additive release rate.

The incompatible additives suitable for use in the invention may be defined as additives which cannot be used in the functional fluid because the additive is insoluble in and/or incompatible with the fluid, is not soluble enough in and/or not compatible enough with to allow for any practical treatment level in the fluid, or is not soluble enough in and/or not compatible enough with to allow for the optimal treatment level to be used in the fluid.

In some embodiments, the incompatible additives of the invention are not completely soluble in oil, or a fresh functional fluid composition, at 20 degrees C. at concentrations of more than 0.5% or 0.1% by weight. In some embodiments, it would also be desirable to have such incompatible additives present in the fluid at a higher level, but for the solubility/incompatibility limitation.

For the purposes of this invention, an additive may be considered to be substantially insoluble if its solubility in mineral oil, or some other functional fluid, is less than 0.2 wt % (that is 0.2 wt % is the highest concentration of the additive that will dissolve and/or solubilize into the fluid). For the purposes of this invention, an additive may be considered to have low solubility, or be considered to be slightly soluble, if its solubility in mineral oil, or some other fluid, is less than 0.6 wt %.

Additives having such incompatibility with functional fluids in which they would otherwise be useful are not overly limited and include all the types of additive discussed above. Some are discussed in greater detail below.

Friction modifiers often have a chemical structure of one or more long or fatty or waxy chains attached to one or more polar groups. Examples of friction modifiers that have solubility limits in some lubricating compositions include oleamide, glycerol monooleate, C12-14 dialkyl tartrate, and N-oleyl tartrimide. These materials have some limits to their solubility and/or compatibility in additive concentrates packages and/or finished fluids, but they may be considered soluble and/or compatible “enough” at low enough levels. Friction modifiers that tend to have more solubility issues and/or compatibility issues include saturated or longer chain equivalent materials, such as stearamide, glycerol monostearate, C16-18 dialkyl tartrate and N-stearyl tartrimide. These materials may very well be superior friction modifiers in various applications compared to more soluble and/or compatible friction modifiers, however these friction modifiers have significant solubility and/or compatibility issues in various functional fluids, making their use less convenient and in some cases impractical. The use of such friction modifiers are limited due to these issues and the inability to effectively deliver these additives to functional fluids with the conventional methods used.

Viscosity modifiers are usually polymeric materials and as such while they may be soluble in a final lubricant and/or functional fluid, they are often not compatible with additive concentrates designed for lubricants, especially if there are other polymeric materials present, like polyisobutylene based dispersants. This is usually dealt with by adding viscosity modifiers as a separate package apart from the dispersant-detergent-inhibitor (DI) package of performance chemicals. Thus if viscosity modifiers are incorporated in a gel in a controlled released device, they may be conveniently delivered to a lubricant or other functional fluid at a desired rate, thus circumventing compatibility problems that one might have in a concentrate with other chemicals. Viscosity modifiers, including viscosity index (VI) improvers, thus would be considered substantially insoluble or low solubility for the purpose of this invention when they would be incompatible in the concentrate of additives and/or the final lubricating composition.

Other examples of substantially insoluble additives which may be used in the invention include friction modifiers such as dihexadecyl tartrate, dioctadecyl tartrate, di-C14-18 dialkyl tartrate, stearamide, oleamide, mixtures of oleamide and stearamide, oleyl tartrimide, mixtures of N-stearyl tartrimide and N-oleyl tartrimide, C24-28 alkenyl succinimide, C24-28 alkyl phenol, N-hexadecyl malimide and 1-dodecyl-5-oxo-pyrrolidine-3-carboxylic acid dodecylamide, and foam inhibitors such as trimethyl-trifluoropropylmethyl siloxane.

Means of Delivery. The various supplemental additive packages described above are used to supply additive to the functional fluid of an engine during the engine's operation. The means of that delivery is not overly limited and includes manual, mechanical, and automatic dosing of the supplemental additive package into the functional fluid. The means of delivery may also comprise controlled release by means of dissolution and/or extraction of additives from the supplemental additive package into the fluid that takes place when the package and fluid are in contact with one another. In some embodiments, they are placed in contact with the fluid by means of a fluid conditioning device. The device is placed in the functional fluid system of the engine, contains the supplemental additive package and provides for the contacting of the package and the fluid during the operation of the engine.

The supplemental additive package may be added and/or positioned anywhere in the functional fluid system of the device such that the package comes into contact with the fluid, is able to mix into the fluid, and/or dissolve and/or melt into the fluid.

In embodiments where the supplemental additive package includes a liquid composition, the package may be added to the functional fluid sump, such as an oil sump of an engine, a fluid line that circulates the functional fluid, a fluid filter which the functional fluid circulates through, or any other point that will allow the liquid composition to mix into the functional fluid. In some embodiments a split sump or separate fluid sump may be used to hold the package and add it to the primary sump, or any other location in the system described herein.

In embodiments where the supplemental additive package includes a solid composition, a gel composition, or a liquid composition contained within some type of device or capsule, the package may be placed anywhere inside the device and/or functional fluid system in the device where the package will come into contact with the functional fluid. The package and/or device that allows for the contacting of the package and the fluid may be located in: a fluid filter; an additive bead or pellet, which may be added to the functional fluid composition at any point; a fuel tank cap; an oil drain plug; a fluid line bypass canister; an air filter; or combinations thereof.

The supplemental additive package may be located in the fluid sump, inside a fluid filter, in a fluid line or bypass fluid line assembly, or combinations thereof. The package may also be built into a cap, plug, lid or similar item that is part of the fluid system and where the inside service of the item, where the package may be located, comes into contact with the functional fluid.

In one embodiment the functional fluid is an engine oil, the device is an internal combustion engine, and the supplemental additive package is positioned in the engine oil system, which includes the lubricating system, filter, drain pan, oil bypass loop, canister, housing, reservoir, pockets of a filter, canister in a filter, mesh in a filter, canister in a bypass system, mesh in a bypass system, oil lines and the like. In one embodiment the fluid is a gear oil and the package is located in the gear system which includes oil drain pan, sump, filters, a full flow or bypass oil line, lines, loop and/or filter, canisters, mesh, other spaces within the device in which a gel might be contained and the like. In one embodiment the fluid is transmission fluid and the package is located in the transmission system which includes the space such as a hole within a transmission magnet, the oil pan, oil lines, lines, canisters, mesh and the like. In one embodiment the package is located in the engine oil line, which includes a full flow filter, a by-pass filter, the oil pan, and the like. In one embodiment, the functional fluid is a hydraulic fluid and the supplemental additive package is located in the hydraulic cylinder, sump, filter, oil lines, pan, full flow or by pass fluid loop, line and/or filter, canister, mesh, other spaces in the system and the like.

One or more locations in a fluid line, loop and/or other locations in a functional fluid system can contain the supplemental additive package. Further, if more than one package is used, each package may have a different formulation and may be placed in the same or different locations in the system.

In one embodiment it is desirable to provide a container to hold the supplemental additive package, such as a housing, a canister or a structural mesh anywhere in the fluid system, for example, a canister within a bypass loop of a stationary gas engine for power generation. The necessary design feature for the container is that at least a portion of the package is in contact with the fluid.

In other embodiments, the supplemental additive package is used without such a container or containment device. In these embodiments the package may be a liquid that is dosed into the functional fluid, a gel and/or solid composition that does not require a container, a gel and/or solid composition that is in the form of particles (large or small) dispersed in the functional fluid and/or attached to a section of the fluid system, or combinations thereof.

The supplemental additive package needs to be in contact with the functional fluid. In one embodiment the package is in contact with the fluid in the range of about 100% to about 1% of the volume of the fluid flowing in the system and/or is exposed to 100% to about 1% of the flow rate of the fluid through the system. In another embodiment the package is in contact with the fluid, in regards to volume or flow rate, in the range of about 75% to about 25%, or about 50% of the fluid in the system. Generally, as the flow rate decreases there is less dissolution of the package and as the flow rate increases there is greater dissolution of the package.

In one embodiment, the supplemental additive package is positioned in the functional fluid system so that the package and/or any container it is located within can easily be removed, and then replaced with a new supplemental additive package and/or supplemental additive package container.

The rate of release of additives from the supplemental additive package to the functional fluid may be determined by the formulation of the package. For example, the release rate of a gel composition is determined by the stiffness, consistency, homogeneity and the like, or the gel composition, as well as the conditions it is exposed to in the system. The desired overall dissolution of the supplemental additive package, the desired release rates of a specific component within the package, or combinations thereof may be determined by the formulation of the package. The release rate of the package is also dependent on the mode of addition of the package, the location of package, flow rate of the functional fluid, the form of the package and the like.

The supplemental additive package of the invention may comprise and/or be enveloped within a coating or contain a carrier compound. The coating or carrier may provide for the controlled release of the package to the functional fluid by acting as a barrier and/or binder that prevents the additives of the package from leaving the composition and entering the fluid composition. Then, at some other point in time, the coating or carrier component may melt, dissolve, or otherwise stop acting as a barrier and/or binder, and allow the additives of the package to enter the fluid. In some embodiments, where such a component is used, this carrier component, which may also act as a coating and/or a binder, may comprise a polymer, an organic chemical or mixture of chemicals with a melting point that is >40 C, but <200 C, an inorganic filler which has a melting point that is >40 C, but <200 C, or combinations thereof. In other embodiments the supplemental additive packages of the invention are free of such binders and/or coatings and no carrier component is present.

The invention may provide improvement in the performance of the functional fluid, and so also an improvement in the device using the fluid. This improvement in the performance of the fluid may include: increased fluid durability; decreased levels of soot and/or byproducts in the fluid over the course of its use and/or reduced soot thickening; extended drain intervals and/or fluid service life; and combinations thereof. The resulting improvement in the performance of the device may include: improved economy, such as in improved fuel economy in the case of an engine; reduced pollution, such as reduced emissions of soot, particulates, and/or combustion byproducts in the case of an engine; and combinations thereof.

The benefit provided by the methods of the invention may be described as restoring functional fluid performance. For example, where the fluid is an engine oil, the operation of an engine using the oil breaks the oil down, possibly making the oil deficient in one or more areas, particularly if the engine is operated under severe and/or harsh conditions. This reduces the service live of the oil and results in a shorted drain interval. The methods of the present invention may be sued to restore the oil and so restore the service life and longer drain internal, during which the oil will still provide sufficient, and in some cases even improved, performance.

In some embodiments the invention allows for the functional fluid, such as a lubricant used in an engine, to have a final total base number (TBN) at the end of its service life (determined by OEM standards, TBN-TAN crossover using ASTM D4739 or D2896 (TBN) and D664A (TAN) methods, and/or other established analytical means) that is no less than 70%, 80%, or 90% of the total base number of the functional fluid before its use in the device. In some embodiments the base number may actually increase over its service life due to the combination with the supplemental additive package of the invention.

In some embodiments the invention allows for the fluid, such as a lubricant, to have a final total acid number (TAN, as defined above) at the end of its service life (as described above) that has increased no more than 50%, 100%, 275%, or 285% of fluid's original TAN.

In some embodiments the invention allows for the fluid, such as a lubricant used in an engine, to have a final viscosity (as defined by Sequence IIIG oil thickening increase @40 C) at the end of its service life (as described above) that has increased no more than 25%, 50%, 100%, or 150% of the fluid's original viscosity value.

In some embodiments the invention allows for the fluid, such as a lubricant, to have a final coefficient of friction (COF, as measured by the high frequency reciprocating rig described in SAE Paper 2007-01-4134.) at the end of its service life (as described above) that has not increased any more than 25%, 50%, 100%, or 150% of the fluid's original COF value.

In some embodiments the invention allows for the fluid, such as a lubricant, to have a final wear characteristics (as defined by Sequence IIIG average cam and lifter wear and/or IVA average cam wear) at the end of its service life (as described above) that has not increased any more than 25%, 50%, 100%, or 150% of the wear characteristics of the fluid before its use in the device.

In some embodiments the invention allows for the fluid, such as a lubricant, to have a final foaming characteristics (as defined by ASTM D892 A and/or ASTM D6082 A) at the end of its service life (as described above) that has not worsened any more than 25%, 50%, 100%, or 150% of the foaming characteristics of the original fluid.

In some embodiments the invention allows for the fluid, such as a lubricant, to have a final oxidation tendency characteristics (as defined by PDSC induction time, as measured by ASTM D6186 and/or D6594) at the end of its service life (as described above) that has not decreased any more than 25%, 50%, 100%, or 150% of the fluid before its use in the device.

In some embodiments, the invention allows for the fluid, such as a lubricant, to have a final corrosion tendency (as defined by the Mack T12 Pb bearing corrosion for Diesel engines, the Ball Rust Test gray value and/or bearing weight loss in the Sequence VIII for gasoline engines or bench test simulations thereof) at the end of its service life (as described above) that has not worsened any more than 25%, 50%, 100%, or 150% of the corrosion characteristics of the original fluid.

In some embodiments the invention allows for the fluid, such as a lubricant, to have a final sludge formation characteristics (as defined by % coagulated pentane insolubles in ASTM D893) at the end of its service life (as described above) that has not increased any more than 2-fold, 5-fold or 10-fold of the values derived from the fluid before its use in the device.

In some embodiments the invention allows for the fluid, such as a lubricant, to have a final soot handling performance characteristics (as defined by the MRV @−20 C of 180 hr sample and yield stress by D4684M in the Mack T11 Test) at the end of its service life (as described above) that has not increased by more than 25%, 50%, 100%, or 150% of the values derived from the fluid before its use in the device.

In some embodiments of the invention, the invention provides for one or more of the various conditions described above.

### Specific Embodiment

The invention will be further illustrated by the following examples, which sets forth particularly advantageous embodiments. While the examples are provided to illustrate the invention, they are not intended to limit it.

Composition A—Functional Fluid. A lubricating oil composition, suitable for lubricating an internal combustion engine, is prepared by mixing: 18 parts by weight (pbw) of a 4 cSt synthetic base oil; 53 pbw of a 6 cSt synthetic base oil; 9 pbw of a synthetic ester base oil, 5.5 pbw, of a olefin copolymer (OCP) viscosity modifier and 14.5 pbw of an additive package.

The additive package used to prepare Composition A is prepared by mixing: 50 pbw ashless PIB succinimide dispersant; 2.7 pbw mineral oil; 3.4 pbw zinc alkyldithiophosphate agents; 6.3 pbw alkyl amine antioxidant; 12.5 pbw alkyl phenol antioxidant; 2.5 pbw sulfurized olefin antiwear agent; 0.5 pbw molybdenum dithiocarbamate; 2.5 pbw ashless friction modifier; 0.6 pbw oleylamine friction modifier; 0.9 pbw alkyl borate anti-corrosion agent; 14.4 pbw 300 TBN overbased sulfonate detergent; 3.8 pbw 400 TBN overbased sulfonate detergents; 0.06 pbw foam inhibitor.

Composition B-1—Supplemental Additive Package. A liquid supplemental additive package is prepared by mixing: 13 pbw ashless PIB succinimide dispersant; 39 pbw mineral oil; 7 pbw alkyl amine antioxidant; 7 pbw alkyl phenol antioxidant; 1 pbw molybdenum dithiocarbamate; 26 pbw 400 TBN overbased sulfonate detergent; and 7 pbw PIBSA derived from 2000 Mn

Composition B-2—Supplemental Additive Package. A gel supplemental additive package is prepared by mixing: 11 pbw alkyl aromatic amine antioxidant; 11 pbw alkyl phenol antioxidant; 43.5 pbw 400 TBN overbased sulfonate detergent; 22 pbw ashless RIB succinimide dispersant; 11 pbw 2000 MW PIBSA; and 2 pbw molybdenum dithiocarbamate. The mixture is then placed in a container of the desired shape and held at 100 degrees C. for at least 6 hours. During this cure the mixture forms a gel composition.

The Sequence IIIG test procedure is used to evaluate the invention. The sequence IIIG test procedure is well known in the industry and uses a 1996/1997 231 CID (3800 cc) Series II GM V-6 fuel-injected gasoline engine which is run under high speed and high temperature service conditions for 100 hours. In the present evaluation, the IIIG test procedure was extended to triple the normal length. In the Comparative Example, Composition A is used in the engine atone. In the Inventive Example, Composition A is used in combination with Composition B-1, which is added to the engine's lubricating system in uniform portion at regular intervals. 983 grams of Composition B-1 is added over the course of the 375 hour engine test period. The results of the testing are summarized in the table below, where the tests were performed on the oil at the end of the engine test.

TABLE 1
Summary of Test Results

| | | | Inventive |
|---|---|---|---|
| | Baseline | Comparative | Example 1 |
| | Unused | Example 1 | A + B-1 at |
| | Fresh A | A at EOT | EOT |
| DSC Onset (min) (by D6186) | 171 | 8 | 90 |
| FTIR Oxidation (%) | 60 | 100 | 86 |
| Coagulated Pentane Insolubles | 0.22% | 5.09% | 0.53% |
| (%) (by D 893) | | | |
| % ZDP Remaining¹ | 100% | 0% | 5% |
| % Amine AO Remaining¹ | 100% | 0% | 10% |
| % Phenol AO Remaining¹ | 100% | 0% | 10% |
| TBN (by D4739) | 8.2 | 1.3 | 21.6 |
| TAN (by D664A) | 2.3 | 8.9 | 8.6 |
| Ball Rust Test (by D6557) Avg² | 134 | 116 | 132 |
| Bearing Corrosion Test^{2,3,4} | 11 | 3795 | 395 |
| Cummins Corrosion Test | | 2150 | 162 |
| (by D6594)^{2,3} | | | |
| Lead Corrosion (mg of Pb lost)^{2,5} | 10 | 1367.5 | 165.7 |

¹The percent remaining values of the ZDP (zinc dithiophosphate), Amine AO (alkyl amine antioxidant) and Phenol AO (alkyl phenol antioxidant) were determined by permittivity testing.
²The Ball Rust Tests, Bearing Corrosion Tests, Cummins Corrosion Test and Lead Corrosion Tests were completed using the baseline fluid, the used drain fluid from Comparative Example 1 and the used drain fluid from Inventive Example 1. Where tests gave multiple readings, the average of all results is reported.
³The reported values in the Bearing Corrosion Test and Cummins Corrosion Test are in ppm and are to combined total of ppm of Cu and ppm Pb present in the sample at the end of the test.
⁴This is a bench test which simulates bearing weight loss in Sequence VIII test.
⁵This is a bench test which simulates Pb corrosion component of bearing loss in Sequence VIII test.

The results show that the invention improves the performance of a functional fluid, such as a lubricant, by continually reinvigorating and/or rejuvenating the fluid over its use so that it looks more like new, unused fluid during and after its service life compared to fluid used alone. Specifically, the invention helps keep lubricant TBN up, TAN down, oxidation low, coagulated pentane insolubles low, additive levels up, and corrosion and wear down.

Each of the documents referred to above is incorporated herein by reference, Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, all percent values listed herein are on a weight basis. Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent, which may be customarily present in the commercial material, unless otherwise indicated. It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration.

In addition, all the embodiments described above have been contemplated as to their use, both alone and in combination, with all of the other embodiments described above, and these combinations are considered to be part of the invention. The specific embodiments of amines and alcohols described above have been contemplated in combination with the specific embodiments of the carboxylic acids useful in the invention.

We claim:

1. A method of operating a functional fluid-utilizing device comprising:
a. supplying to the device a functional fluid composition;
b. operating the device containing the functional fluid composition;
c. adding to the functional fluid composition, during the operation of the device, a supplemental additive package;
d. resulting in a performance improvement of the functional fluid composition during its service life and/or an extension of the functional fluid composition's service life.

2. The method of claim 1 wherein the functional fluid composition has a deficient amount of one more types of additives.

3. The method of claim 1 wherein the functional fluid is a lubricating composition, the functional fluid-utilizing device comprises an engine, and wherein the lubricating composition comprises a major amount of an oil of lubricating viscosity and a minor amount of an additive package, wherein the additive package has a deficient amount of one more types of additives.

4. The method of claim 1 wherein the functional fluid composition has a deficient amount of one or more of the following additives: antioxidants, friction modifiers, viscosity modifiers, antiwear agents, antifoam agents, detergents, and dispersants; and wherein the fluid is deficient when it is added to the device or only after some period of use in the device.

5. The method of claim 1 wherein the addition of the supplemental additive package to the functional fluid composition is a controlled additization accomplished by at least one of the following:
a. a fluid additive gel;
b. a mixture of a carrier with the additive wherein the carrier is at least partially soluble in the lubricating composition;
c. a liquid additive mechanical dosing system;
d. an additive partially or fully encapsulated by a material which is at least partially soluble in the lubricating composition.

6. The method of claim 1 wherein the means of accomplishing the additization comprises a containment device which holds the supplemental additive package and allows for it to come into contact with the functional fluid composition.

7. The method of claim 1 wherein the means of accomplishing the additization are at least partially contained within one or more of the following:
a. a fluid filter;
b. an additive bead or pellet, which may be added to the lubricant composition;
c. a fuel tank cap;
d. an oil pan and/or oil drain plug;
e. a fluid line bypass canister;
f. an air filter.

8. The method of the claim 3 wherein the lubricating composition has at least one of the following characteristics:
a. the lubricating composition contains an amount of friction modifier below the minimum amount required for the composition to obtain a passing result in the VIb engine test;
b. the lubricating composition contains an amount of antioxidant below the minimum amount required for the composition to obtain a passing result in the IIIG engine test.

9. The method of claim 1 wherein the functional fluid composition is substantially free of one or more of the following additives: antioxidants, friction modifiers, viscosity modifiers, antiwear agents, antifoam agents, detergents, and dispersants.

10. The method of claim 3 wherein the combination of the supplemental additive package and the lubricating composition results in at least one of the following conditions:
a. the total base number of the lubricating composition does not fall below 70% of its original value, as defined by ASTM D4739 or D2896, over the composition's service life;
b. the total acid number of the lubricating composition does not rise more than 285% above its original value, as defined by ASTM D664A, over the composition's service life;
c. the viscosity of the lubricating composition remains within 50% of its original value, as defined by ASTM D445 at 40° C. and/or D445 at 100° C., over the composition's service life;
d. the coefficient of friction of the lubricating composition remains within 50% of its original value as measured by the high frequency reciprocating rig described in SAE Paper 2007-01-4134, over the composition's service life;
e. the wear characteristics of the lubricating composition are reduced by at least 50% of the values obtained in the absence of the supplemental additive package, as defined by Sequence IIIG average cam and lifter wear and/or IVA average cam wear;
f. the foaming tendency of the lubricating composition remains within 50% of its original value, as defined by ASTM D892 A and/or ASTM D6082 A, over the composition's service life;
g. the oxidation tendency of the lubricating composition remains within 50% of its original value, as defined by PDSC induction time, as measured by ASTM D6186 and/or D6594, over the composition's service life;
h. the copper and lead corrosion tendency of the lubricating composition remains within 50% of its original value as defined by the Mack T12 Pb bearing corrosion for Diesel engines, the Ball Rust Test gray value and/or bearing weight loss in the Sequence VIII for gasoline engines or bench test simulations thereof over the composition's service life;
i. the sludge formation characteristics, as defined by % coagulated pentane insolubles in ASTM D893, of the lubricating composition remains less than 2 times of its original value;
j. the soot handling performance characteristics, as defined by the MRV at −20° C. of 180 hr sample and yield stress by D4684M in the Mack T11 Test, of the lubricating composition remains within 50% of its original value;
k. combinations thereof.

11. The method of claim 1 wherein the performance improvement of the functional fluid composition comprises:
a. increased functional fluid durability;
b. increased fuel economy;
c. increased soot reduction;
d. extended drain interval and/or functional fluid service life; and
e. combinations thereof.

12. A method of lubricating an engine comprising:
a. supplying to the engine a lubricating composition comprising a major amount of an oil of lubricating viscosity and a minor amount of an additive package;
b. operating the engine containing the lubricating composition;
c. adding to the lubricating composition, during the operation of the engine,
d. at least one supplemental additive in a controlled manner;
resulting in a performance improvement of the lubricating composition during its service life and/or an extension of the lubricating composition's service life.

13. The method of claim 12 wherein the additive package of the lubricating composition has a deficient amount of one more types of additives.

14. The method of any of claim 12 wherein the supplemental additive supplied to the lubricating composition comprises base oil, wherein the base oil is released in a controlled manner to the lubricating composition, resulting in the improved control of the lubricating composition's viscosity over the service life of the lubricating composition.
